(19) United States
(12) Patent Application Publication
(10) Pub. No.: US 2015/0085495 A1
(43) Pub. Date: Mar. 26, 2015

(54) LAMP AND LIGHTING APPARATUS

(71) Applicant: PANASONIC INTELLECTUAL PROPERTY MANAGEMENT CO., LTD., Osaka (JP)

(72) Inventor: Katsushi Seki, Shiga (JP)

(73) Assignee: PANASONIC INTELLECTUAL PROPERTY MANAGEMENT, Osaka (JP)

(21) Appl. No.: 14/395,634

(22) PCT Filed: Mar. 28, 2013
(86) PCT No.: PCT/JP2013/002132

§ 371 Date: Oct. 20, 2014

(30) Foreign Application Priority Data
Apr. 26, 2012 (JP) 2012-101767

(51) Int. Cl. F21V 17/16; F21V 29/00; F21K 99/00

(52) U.S. Cl. CPC F21V 17/16; F21K 9/54; F21V 29/004
USPC 362/310

(57) ABSTRACT

A lamp including: a reflecting mirror; a case inside which the reflecting mirror is entirely or partially disposed, and which has an opening formed therein; and a light-transmissive cover covering the opening of the case. The reflecting mirror includes a case-side reflecting mirror connecting part for connecting with the case, and the case includes a mirror-side case connecting part which connects with the case-side reflecting mirror connecting part. The case further includes a cover-side case connecting part for connecting with the light-transmissive cover, and the light-transmissive cover includes a case-side cover connecting part which connects with the cover-side case connecting part. The light-transmissive cover further includes a mirror-side cover connecting part for connecting with the reflecting mirror, and the reflecting mirror further includes a cover-side reflecting mirror connecting part which connects with the mirror-side cover connecting part.

### TECHNICAL FIELD

The present invention relates to a lamp using a light-emitting element such as a light-emitting diode (LED) as a light source and to a lighting apparatus including the lamp.

### BACKGROUND ART

Conventionally, disc-shaped or low-profile LED lamps using LEDs as a light source have been proposed (for example, see Patent Literature (PTL) 1). Generally, such LED lamps include a disk-shaped or low-profile case which contains an LED board on which an LED is mounted, and a cover component which covers an opening of the case. Furthermore, the cover component is connected and secured to the case through an adhesive or an interfitting structure.

### CITATION LIST

### Patent Literature

PTL 1: International Publication No. WO2012/005239

### SUMMARY OF INVENTION

### Technical Problem

However, with the above-described conventional LED lamp, there are cases where the connection between the cover component and the case breaks due to deterioration, and the like, caused by the heat when the light is on. Then, when the connection between the cover component and the case is broken, the cover component falls off.

Furthermore, since a reflecting component which reflects the light from the LED, and so on, are also disposed inside the case, there is the possibility that the reflecting component, and so on, may also drop together with the cover component when the cover component falls off from the case. Since, in general, such LED lamps are usually located overhead, it is very important to reduce as much as possible the possibility of such components dropping.

The present invention is conceived in view of the aforementioned problem and has as an object to provide a lamp and a lighting apparatus which are capable of preventing components from dropping even when the connection between the cover component and the case breaks.

### Solution to Problem

In order to achieve the aforementioned object, a lamp according to an aspect of the present invention is a lamp that emits light and includes: a board on which a light-emitting element is provided; a reflecting component which is disposed on a light-emission-side of the board, and reflects light emitted from the light-emitting element; a case inside which the reflecting component is entirely or partially disposed, and which has an opening formed on the light-emission side; and a cover component which covers the opening formed in the case, wherein the reflecting component includes a case-side reflecting component connecting part for connecting with the case, and the case includes a reflecting component-side case connecting part which connects with the case-side reflecting component connecting part, the case further includes a cover-side case connecting part for connecting with the cover component, and the cover component includes a case-side cover connecting part which connects with the cover-side case connecting part, and the cover component further includes a reflecting component-side cover connecting part for connecting with the reflecting component, and the reflecting component further includes a cover-side reflecting component connecting part which connects with the reflecting component-side cover connecting part.

Furthermore, the case-side reflecting component connecting part and the reflecting component-side case connecting part may be shaped to be engageable with each other, the cover-side case connecting part and the case-side cover connecting part may be shaped to be engageable with each other, and the reflecting component-side cover connecting part and the cover-side reflecting component connecting part may be shaped to be engageable with each other.

Furthermore, the reflecting component may include a plurality of the case-side reflecting component connecting parts which are arranged equidistantly along a loop, and the case may include a plurality of the reflecting component-side case connecting parts each of which corresponds to a different one of the case-side reflecting component connecting parts, the case may include a plurality of the cover-side case connecting parts which are arranged equidistantly along a loop, and the cover component may include a plurality of the case-side cover connecting parts each of which corresponds to a different one of the cover-side case connecting parts, and the cover component may include a plurality of the reflecting component-side cover connecting parts which are arranged equidistantly along a loop, and the reflecting component may include a plurality of the cover-side reflecting component connecting parts each of which corresponds to a different one of the reflecting component-side cover connecting parts.

Furthermore, when seen from a center of the lamp, one or more case-side cover connecting parts including the case-side cover connecting part are arranged in a loop at positions which may be different from positions, in a loop, at which one or more reflecting component-side cover connecting parts including the reflecting component-side cover connecting part are arranged.

Furthermore, the cover component may further include a rotation positioning part located at both sides of the reflecting component-side cover connecting part, the rotation positioning part determining a rotation position of the cover component with respect to the reflecting component by interfitting with the cover-side reflecting component connecting part.

Furthermore, the cover component may further include a rotation regulating part which regulates rotation of the cover component with respect to the case, by abutting a projecting part of the case which projects towards an inside of the case.

Furthermore, in order to achieve the aforementioned object, a lighting apparatus according to an aspect of the present invention includes: the above-described lamp; and lighting equipment to which the lamp is attached, wherein the lighting equipment includes: a main body configured to cover the lamp; and a socket attached to the main body, for supplying power to the lamp.

### Advantageous Effects of Invention

According to a lamp and a lighting apparatus according to the present invention, it is possible to prevent components from dropping even when the connection between the cover component and the case breaks.

### BRIEF DESCRIPTION OF DRAWINGS

FIG. 1A is a perspective view of an external appearance of a lamp according to Embodiment 1 of the present invention.

FIG. 1B is a perspective view of an external appearance of the lamp according to Embodiment 1 of the present invention.

FIG. 2 is a diagram showing a configuration of the lamp according to Embodiment 1 of the present invention.

FIG. 3 is an exploded perspective view of the configuration of the lamp according to Embodiment 1 of the present invention.

FIG. 4 is a perspective view of a configuration of a case according to Embodiment 1 of the present invention.

FIG. 5 is a perspective view of a configuration of a reflecting mirror according to Embodiment 1 of the present invention.

FIG. 6 is a perspective view of a configuration of a light-transmissive cover according to Embodiment 1 of the present invention.

FIG. 7 is a diagram showing a positional relationship between the light-transmissive cover, and the case and reflecting mirror according to Embodiment 1 of the present invention.

FIG. 8 is a diagram showing a connecting state between the case and the reflecting mirror according to Embodiment 1 of the present invention.

FIG. 9 is a diagram showing a connecting state between the light-transmissive cover, and the case and reflecting mirror according to Embodiment 1 of the present invention.

FIG. 10 is a cross-sectional view of a configuration of a lighting apparatus according to Embodiment 2 of the present invention.

### DESCRIPTION OF EMBODIMENTS

Hereinafter, lamps and lighting apparatuses according to exemplary embodiments of the present invention shall be described with reference to the Drawings. It should be noted that each of subsequently-described embodiments show one specific preferred example of the present invention. The numerical values, shapes, materials, structural components, the arrangement and connection of the structural components, etc. shown in the following exemplary embodiments are mere examples, and are not intended to limit the scope of the present invention. Furthermore, among the structural components in the following exemplary embodiments, components not recited in any one of the independent claims are described as arbitrary structural components included in a more preferable form. Moreover, in the respective figures, dimensions, etc. are not precise. Furthermore, in the present application, numerical ranges defined using the word “between” include the numerical values at both end-points.

### Embodiment 1

First, an outline configuration of a lamp 1 according to Embodiment 1 of the present invention shall be described.

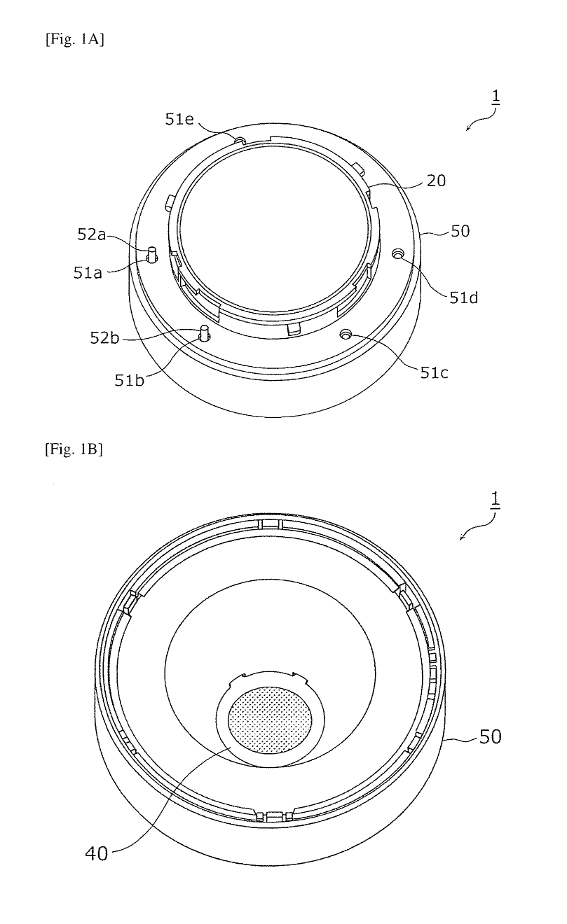

FIG. 1A and FIG. 1B are perspective views of the external appearance of the lamp 1 according to Embodiment 1 of the present invention. Specifically, FIG. 1A is a perspective view of the lamp 1 when viewed obliquely from above, and FIG. 1B is a perspective view of the lamp 1 when viewed obliquely from below. It should be noted that, although an opening of the lamp 1 is covered by a cover, the cover is of a transparent material and thus the inside of the lamp 1 can be seen through the cover in FIG. 1B.

As shown in these figures, the lamp 1 is an LED lamp having a disk-like or low-profile overall shape. Specifically, the lamp 1 is an LED lamp having a GH76p base. More specifically, the lamp 1 has, for example, an outer diameter of between 50 and 100 mm and a height of between 30 and 50 mm, and when the lamp is a 20 W LED lamp, for example, the outer diameter is 90 mm and the height is 45 mm.

Furthermore, the lamp 1 includes a support 20 that is attached to lighting equipment (not illustrated), a mounting board 40 on which a light-emitting element is provided, and a case 50 that is connected to the support 20.

It should be noted that, in FIG. 1A, the lamp is illustrated in such a way that the side where light is elicited from the lamp (hereafter called light-emission-side) is the underside, and, in FIG. 1B, the lamp is illustrated in such a way that the light-emission-side is the topside. Hereinafter, in this embodiment, up (topside) and down (underside) shall be defined with reference to the state in which an LED lamp is disposed such that the light-emission-side is the underside, as in FIG. 1A.

Furthermore, five through holes 51 (through holes 51a to 51e in the figure) are formed along a circle in the top face (face on the lighting equipment-side) of the case 50. An electrical connection pin 52 for electrically connecting with the lighting equipment is inserted in each through hole 51. It should be noted that, although electrical connection pins 52a and 52b are inserted through the through holes 51a and 51b in the figure, electrical connection pins 52c to 52e (not illustrated) are also inserted through the through holes 51c to 51e, respectively. Here, for example, the electrical connection pins 52a and 52b are power supply pins, the electrical connection pins 52c and 52d are light adjustment pins, and the electrical connection pin 52e is a grounding pin. It should be noted that, for example, in the case where light adjustment will not be performed, the through holes 51c and 51d are not formed and the electrical connection pins 52c and 52d are not inserted.

Next, the detailed configuration of the lamp 1 according to Embodiment 1 of the present invention shall be described.

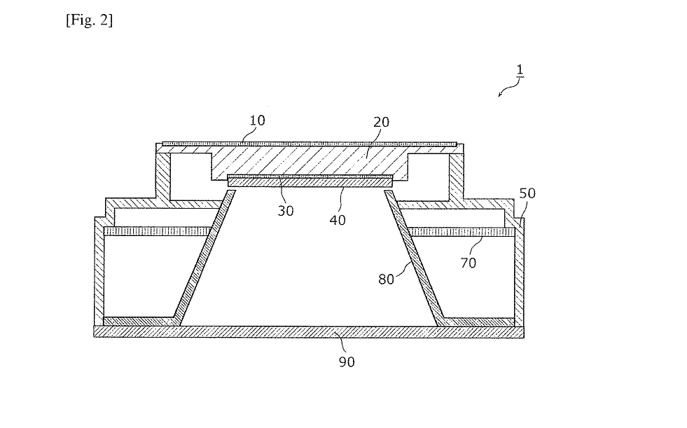

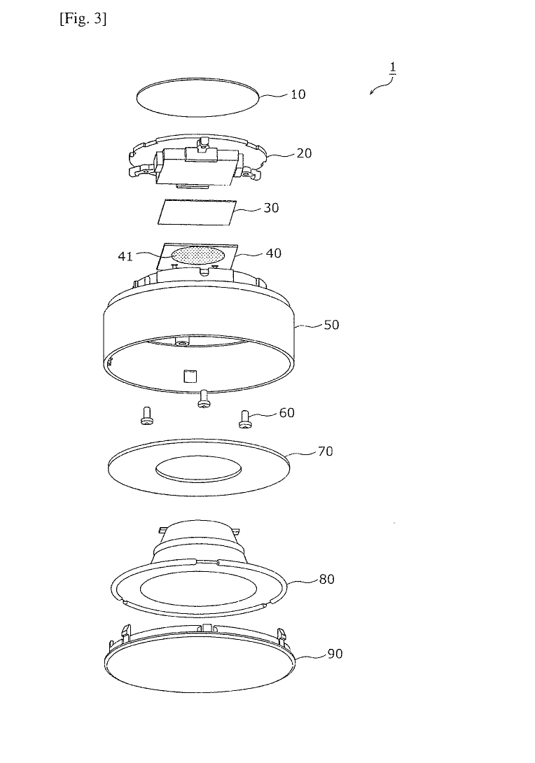

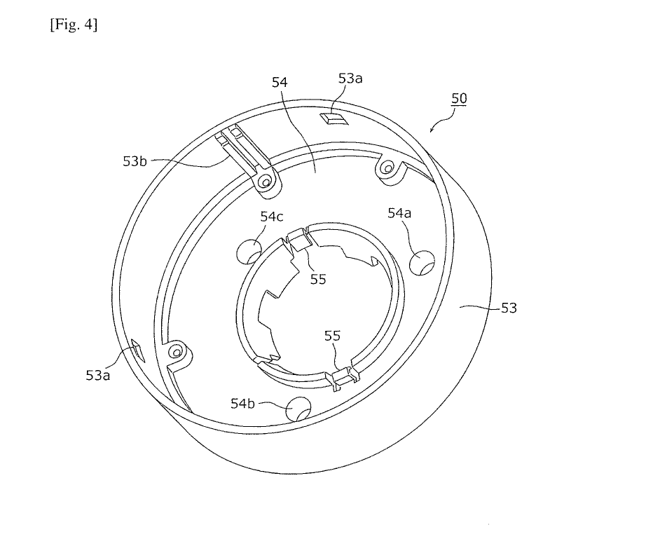

FIG. 2 and FIG. 3 are diagrams showing the configuration of the lamp 1 according to Embodiment 1 of the present invention. Specifically, FIG. 2 is an outline diagram of the cross-section obtained when the lamp 1 is cut vertically, and FIG. 3 is an exploded perspective view of the respective structural components when the lamp 1 is disassembled. Moreover, FIG. 2 is an outline diagram for describing the positional relationship of the respective structural components, and the structure, and so on, of the connecting parts of the respective structural components are omitted in the illustration.

As shown in these figures, the lamp 1 includes a heat-conducting sheet 10, the support 20, a heat-conducting sheet 30, the mounting board 40, the case 50, securing screws 60, a circuit board 70, a reflecting mirror 80, and a light-transmissive cover 90.

The heat-conducting sheet 10 is a heat-conductive sheet for releasing, to the lighting equipment-side, the heat from the mounting board 40 that is transmitted via the support 20. Specifically, the heat-conducting sheet 10 is a sheet made of rubber or resin, and is, for example, a silicon sheet or an acrylic sheet.

The support 20 is a component that is connected to the lighting equipment. Specifically, for example, a GH76p base structure is formed in the upper part of the support 20, and is attached and secured to the lighting equipment. Furthermore, the support 20 is a pedestal on which the mounting board 40 is attached, and is disposed on a side opposite the light-emission-side of the mounting board 40. Furthermore, it is preferable that the support 20 be made of highly heat-conductive material such as aluminum.

The heat-conducting sheet 30 is a heat-conducting sheet that thermally connects the mounting board 40 and the support 20. Specifically, the heat-conducting sheet 30 is a heat-conductive sheet that can efficiently transmit the heat from the mounting board 40 to the support 20, and release the heat to the lighting equipment-side. It should be noted that, in the case where the mounting board 40 is a metal board, it is preferable that the heat-conducting sheet 30 be an insulating sheet that provides insulation between the mounting board 40 and the support 20. Specifically, the heat-conducting sheet 30 is a sheet made of rubber or resin, and is, for example, a silicon sheet or an acrylic sheet. Moreover, the heat-conducting sheet 30 may be a liquid component, and so on, such as grease.

The mounting board 40 is a board on which a light-emitting element such as a semiconductor light-emitting element is provided. The mounting board 40 is, for example, configured to be plate-like, and has one face on which the light-emitting element is mounted, and another face that can be thermally connected to the support 20. Furthermore, it is preferable that the mounting board 40 be made of highly heat-conductive material, and is, for example, made of an alumina substrate made of alumina. It should be noted that, aside from an alumina substrate, a ceramic substrate made of other ceramic material such as aluminum nitride, metal substrates made of aluminum, copper, or the like, or a metal-core substrate having a stacked structure of a metal plate and a resin substrate may be used for the mounting board 40. It should be noted that the mounting board 40 is included in the “board” recited in the Claims.

Specifically, a light-emitting unit 41 is provided in the mounting board 40. The light-emitting unit 41 includes plural LED chips (not illustrated) mounted on the mounting board 40, and a sealing component (not illustrated). The LED chips are mounted on one of the faces of the mounting board 40 by die bonding, or the like. It should be noted that, for example, blue LED chips which emit blue light having a central wavelength at between 440 and 470 nm are used as the LED chips. Furthermore, the sealing component is a phosphor-containing resin made of a resin containing phosphor, for protecting the LED chips by sealing the LED chips, as well as for converting the wavelength of the light from the LED chips. As a sealing component, for example, in the case where the LED chips are blue light-emitting LEDs, a phosphor-containing resin in which yttrium, aluminum, and garnet (YAG) series yellow phosphor particles are dispersed in silicone resin can be used to obtain white light. With this, white light is emitted from the light-emitting unit 41 (sealing component) due to the yellow light obtained through the wavelength conversion by the phosphor particles and the blue light from the blue LED chips.

Further, the outer diameter of the light-emitting unit 41 is, for example, between 5 and 50 mm, and when the lamp 1 is a 20 W LED lamp, the outer diameter of the light-emitting unit 41 is, for example, 20 mm.

It should be noted that although a round light-emitting unit 41 is given as an example in this embodiment, the shape or structure of the light-emitting unit in the present invention is not limited to a round one. For example, a square-shaped light-emitting unit may be used. Furthermore, the arrangement of the LED chips is not particularly limited. For example, the LED chips may be sealed in a line, matrix, or circular form.

The case 50 is a low-profile, cylindrical case surrounding the light-emission-side of the lamp 1, and has an opening formed on the light-emission side. Specifically, the upper part of the case 50 is secured to the support 20 by way of the securing screws 60, and the light-transmissive cover 90 is attached to the bottom part of the case 50. In addition, the heat-conducting sheet 30, the mounting board 40, the circuit board 70, and the reflecting mirror 80 are disposed inside the case 50. The case 50 is configured of a resin case made of a synthetic resin having insulation properties, such as polybutylene terephthalate (PBT).

Furthermore, as shown in FIG. 1A, the case 50 includes the electrical connection pins 52 which are power receiving units that receive power for causing the LED chip mounted on the mounting board 40 to emit light. Specifically, the electrical connection pins 52 for supplying power receive alternating-current (AC) power, and the received AC power is input to the circuit board 70 via a lead wire. Detailed description of the configuration of the case 50 shall be provided later.

The securing screws 60 are screws for securing the case 50 to the support 20. It should be noted the case 50 and the support 20 are not limited to being secured using screws. For example, the case 50 and the support 20 may have interfitting parts, and the case 50 may be connected to the support 20 through the interfitting of these parts. Alternatively, the case 50 may be joined to the support 20 by using an adhesive.

The circuit board 70 is a power source circuit board for causing the LED chip mounted on the mounting board 40 to emit light. The circuit board 70 is a disk-shaped hoard in which a circular opening is formed (i.e., donut-shaped board), and is disposed inside the case 50 and outside the reflecting mirror 80. In addition, the circuit element (electronic component) mounted on the circuit board 70 is disposed in the space inside the case 50 and outside the reflecting mirror 80.

Furthermore, since the circuit board 70 is disposed in the upper part of the inside of the case 50, it is preferable that a circuit element in which the size of, for example, an electrolytic capacitor, choke coil, or the like, is large, be disposed on the bottom face-side of the circuit board 70. It should be noted that although the circuit board 70 is illustrated in this embodiment in a form that is displaced inside the case 50 and outside the reflecting mirror 80, the placement location is not particularly limited and may be arbitrarily designed.

Moreover, in the form in which the circuit board 70 is disposed inside the case 50 and outside the reflecting mirror 80, it is preferable that a large-sized circuit element be disposed on the outer portion of the circuit board 70. This is because, as shown in FIG. 2, when the reflecting mirror has a shape in which the radius widens towards the bottom, the space formed in the outer portion of the circuit board 70 is larger than the space formed in the inner portion of the circuit board 70.

Specifically, a circuit element (electronic component), or the like, for converting the AC power received from the electrical connection pins 52 for supplying power into direct-current (DC) power is mounted on the circuit board 70. Specifically, the input unit of the circuit board 70 and the electrical connection pins 52 for supplying power are electrically connected by a lead wire or the like, and the output unit of the circuit board 70 and the light-emitting unit of the mounting board 40 are electrically connected by a lead wire or the like. The DC power obtained from the conversion by the circuit board 70 is supplied to the light-emitting unit of the mounting board 40, via a power supply terminal.

The reflecting mirror 80 is an optical component which is disposed on the light-emission-side of the mounting board 40, and reflects light emitted from the light-emitting unit. In other words, the reflecting mirror 80 reflects, downward, the outgoing light emitted from the light-emitting unit provided in the mounting board 40. Specifically, the reflecting mirror 80 is disposed below the mounting board 40 and inside the case 50, and includes a truncated cylindrical part which is formed to have a radius that gradually increases towards the bottom.

Furthermore, the reflecting mirror 80 is made of a white synthetic resin material having insulation properties. Although it is preferable that the material of the reflecting mirror 80 be a polycarbonate, it is not limited to polycarbonate. It should be noted that, in order to improve reflectivity, the inner face of the reflecting mirror 80 may be coated with a reflective film. It should be noted that the reflecting mirror 80 is included in the “reflecting component” recited in the Claims. Furthermore, detailed description of the configuration of the reflecting mirror 80 shall be provided later.

The light-transmissive cover 90 is a low-profile, cylindrical component having a disk-shaped bottom, which is attached to the bottom face of the case 50 in order to protect the components disposed inside the case 50. The light-transmissive cover 90 is secured to the bottom face of the case 50 by adhesive, rivets, screws, or the like, to cover the opening formed on the light-emission-side of the case 50.

Furthermore, the light-transmissive cover 90 is made of a highly light-transmissive synthetic resin material such as polycarbonate so as to allow transmission of the outgoing light emitted from the light-emitting unit provided in the mounting board 40. It should be noted that paint for promoting light-diffusion may be applied to the inner face of the light-transmissive cover 90. Furthermore, phosphor may be included in the light-transmissive cover 90. In this case, the color of the light emitted from the light-emitting unit can be converted by the light-transmissive cover 90. It should be noted that the light-transmissive cover 90 is included in the “cover component” recited in the Claims. Furthermore, detailed description of the configuration of the light-transmissive cover 90 shall be provided later.

Next, details of the configuration of the case 50 shall be described.

FIG. 4 is a perspective view of the configuration of the case 50 according to Embodiment 1 of the present invention. Specifically, the figure is a perspective view for when the case 50 is viewed obliquely from below.

As shown in the figure, the case 50, includes an annular case side face part 53, and a disk-shaped case top face part 54 disposed above the case side face part 53 and having a circular opening formed therein. In other words, the case 50 is formed to curve inward towards the support 20-side.

Furthermore, plural cover-side case connecting parts 53a which are arranged equidistantly along a loop (in the figure, three cover-side case connecting parts 53a which are arranged equidistantly along a circle) are formed in the inner face of the case side face part 53. Here, the cover-side case connecting parts 53a are connecting parts for connecting with the light-transmissive cover 90.

Specifically, each of the cover-side case connecting parts 53a has a shape which allows engagement with a corresponding one of case-side cover connecting parts 92 of the light-transmissive cover 90 to be described later. More specifically, the cover-side case connecting parts 53a are recessions formed in the inner face of the case side face part 53.

Although three cover-side case connecting parts 53a are formed in this embodiment, the number of the cover-side case connecting parts 53a is not limited to such. It should be noted that, from the viewpoint of stably attaching the light-transmissive cover 90 to the case 50, it is preferable that two or more of the cover-side case connecting parts 53a be formed, and it is more preferable that three or more of the cover-side case connecting parts 53a be formed.

In addition, a projecting part 53b projecting towards the inside of the case is formed in the inner face of the case side face part 53. Here, the projecting part 53b is a part for regulating the rotation of the light-transmissive cover 90. Specifically, the projecting part 53b is a rod-shaped projecting part which extends vertically, and, by abutting a rotation-regulating part 96 of the light-transmissive cover 90 to be described later, is capable of regulating the rotation of the light-transmissive cover 90 with respect to the case 50.

Screw insertion parts 54a to 54c for the insertion of the securing screws 60 are formed in the case top face part 54. Specifically, three securing screws 60 are respectively inserted in the screw insertion parts 54a to 54c, and the case 50 and the support 20 are fastened by being screwed together.

Furthermore, plural mirror-side case connecting parts 55 which are arranged equidistantly along a loop (in the figure, two mirror-side case connecting parts 55 which are disposed opposite each other along a circle) are disposed inside the opening of the case top face part 54. Here, the mirror-side case connecting parts 55 are connecting parts for connecting with the reflecting mirror 80.

Specifically, the mirror-side case connecting parts 55 have a shape which allows engagement with case-side reflecting mirror connecting parts 81a of the reflecting mirror 80 to be described later. More specifically, each of the mirror-side case connecting parts 55 has a U-shape or a V-shape that is recessed toward the bottom.

In this embodiment two of the mirror-side case connecting parts 55 are provided. Here, the mirror-side case connecting parts 55 are provided as twofold drop-prevention parts for preventing the reflecting mirror 80 and the light-transmissive cover 90 from dropping in the case where the connection between the light-transmissive cover 90 and the case 50 breaks. As such, the number of connection locations for the case 50 and the reflecting mirror 80 is set lower than the number of connection points for the light-transmissive cover 90 and the case 50 and the number of connection locations for the light-transmissive cover 90 and the reflecting mirror 80.

It should be noted that, although the number of the mirror-side case connecting parts 55 is not limited to two, in order to prevent the reflecting mirror 80 and the light-transmissive cover 90 from dropping in the case where the connection between the light-transmissive cover 90 and the case 50 breaks, it is preferable that two or more of the mirror-side case connecting parts 55 be provided.

Next, details of the configuration of the reflecting mirror 80 shall be described.

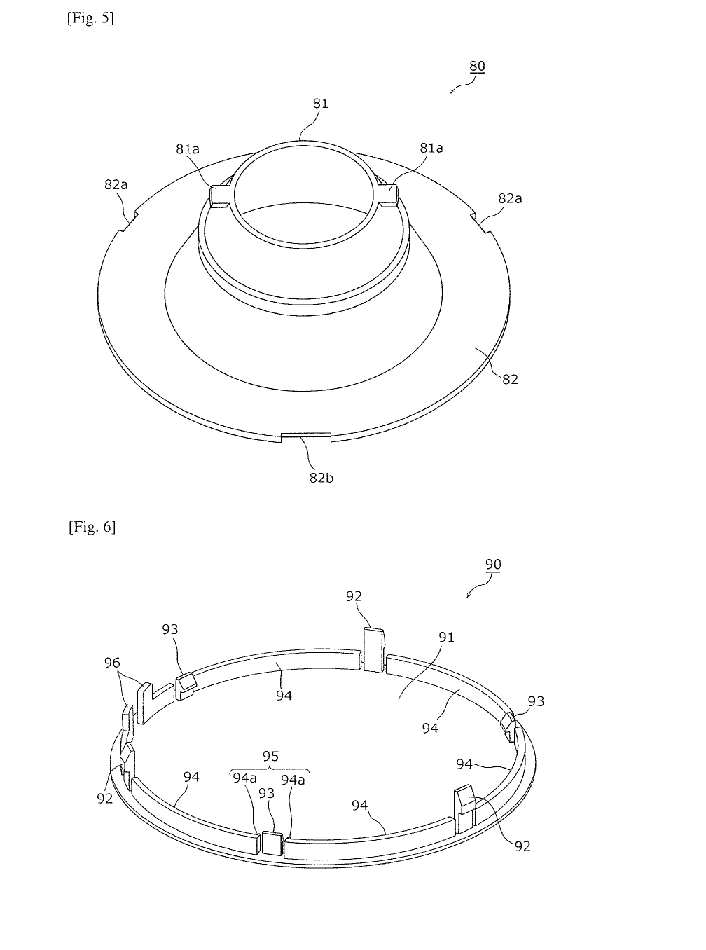

FIG. 5 is a perspective view of the configuration of the reflecting mirror 80 according to Embodiment 1 of the present invention. Specifically, the figure is a perspective view for when the reflecting mirror 80 is viewed obliquely from below.

As shown in the figure, the reflecting mirror 80 includes: a truncated cylinder-shaped reflecting mirror side face 81 which is formed with a radius that gradually increases towards the bottom; and a reflecting mirror bottom face part 82 which has a disk-like shape in which a circular opening is formed (i.e., a donut-shape) and is connected to the bottom face of the reflecting mirror side face 81.

Furthermore, plural case-side mirror connecting parts 81a which are arranged equidistantly along a loop (in the figure, two case-side mirror connecting parts 81a which are disposed opposite each other along a circle) are disposed in the upper part of the reflecting mirror side face 81. Here, the case-side mirror connecting parts 81a are connecting parts for connecting with the reflecting mirror 80.

Specifically, the case-side mirror connecting parts 81a have a shape which allows engagement with the mirror-side case connecting parts 55 of the case 50. In other words, each of the case-side mirror connecting parts 81a is a projecting part that projects outward from the upper part of the reflecting mirror side face 81.

Although two of the case-side mirror connecting parts 81a are formed in this embodiment, the number of the case-side mirror connecting parts 81a is not limited to such. It should be noted that, like the mirror-side case connecting parts 55, in order to prevent the reflecting mirror 80 and the light-transmissive cover 90 from dropping in the case where the connection between the light-transmissive cover 90 and the case 50 breaks, it is preferable that two or more of the case-side mirror connecting parts 81a be provided.

Furthermore, plural cover-side mirror connecting parts 82a and 82b which are arranged equidistantly along a loop (in the figure, two cover-side mirror connecting parts 82a and one cover-side mirror connecting part 82b which are arranged equidistantly along a circle) are formed on the outer periphery of the reflecting mirror bottom face part 82. Here, the cover-side mirror connecting parts 82a and 82b are connecting parts for connecting with the light-transmissive cover 90.

Specifically, the cover-side mirror connecting parts 82a have a shape which allows engagement with mirror-side cover connecting parts 93 of the light-transmissive cover 90 to be described later, and the cover-side mirror connecting part 82b has a shape which allows engagement with the mirror-side cover connecting part 95 of the light-transmissive cover 90 to be described later. Specifically, the cover-side mirror connecting parts 82a and 82b are recessions formed on the outer periphery of the reflecting mirror bottom face part 82, and are formed so that the recession of the cover-side mirror connecting part 82b is wider than the recession of the cover-side mirror connecting part 82b.

Although two of the cover-side mirror connecting parts 82a and one cover-side mirror connecting part 82b are formed in this embodiment, the number of the cover-side mirror connecting parts 82a and 82b is not limited to such. It should be noted that, in order to prevent the light-transmissive cover 90 from dropping in the case where the connection between the light-transmissive cover 90 and the case 50 breaks, it is preferable that two or more of the cover-side mirror connecting parts be provided, and it is more preferable that three or more of the cover-side mirror connecting parts be provided.

Next, details of the configuration of the light-transmissive cover 90 shall be described.

FIG. 6 is a perspective view of the configuration of the light-transmissive cover 90 according to Embodiment 1 of the present invention. Specifically, the figure is a perspective view for when the light-transmissive cover 90 is viewed obliquely from above.

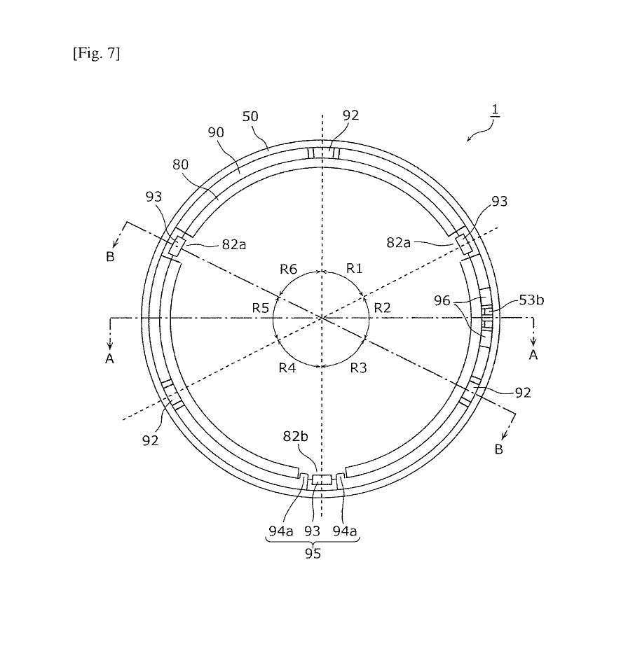

Furthermore, FIG. 7 is diagram showing the positional relationship between the light-transmissive cover 90 and the case 50 and reflecting mirror 80 according to Embodiment 1 of the present invention. Specifically, the figure is a diagram of the lamp 1 in the state in which the case 50, the reflecting mirror 80, and the light-transmissive cover 90 are assembled, when viewed from below.

As shown in these figures, the light-transmissive cover 90 includes a disc-shaped cover bottom face part 91. In addition, case-side cover connecting parts 92, mirror-side cover connecting parts 93, cover side face parts 94, and the rotation-regulating part 96 are disposed to project upward from the cover bottom face part 91.

Specifically, plural case-side cover connecting parts 92 which are arranged equidistantly along a loop (in the figure, three case-side cover connecting parts 92 which are arranged equidistantly along a circle) and plural mirror-side cover connecting parts 93 which are arranged equidistantly along a loop (in the figure, three mirror-side cover connecting parts 93 which are arranged equidistantly along a circle) are provided.

In addition, the case-side cover connecting parts 92, the mirror-side cover connecting parts 93, the cover side face parts 94, and the rotation-regulating part 96 are disposed at different positions along the same circle. In other words, they are disposed at different positions along the same circle when seen from the center of the lamp. It should be noted that all of the case-side cover connecting parts 92, the mirror-side cover connecting parts 93, the cover side face parts 94, and the rotation-regulating part 96 need not be disposed along the same loop, and may be disposed along different loops. In other words, this means that they are disposed along the respective loops at different positions when seen from the center of the lamp.

Here, the case-side cover connecting parts 92 are connecting parts for connecting with the case 50. Specifically, the case-side cover connecting parts 92 have a shape which allows engagement with the cover-side case connecting parts 53a of the case 50. More specifically, each of the case-side cover connecting parts 92 has a shape in which the tip of the protruding part that protrudes upward from the cover bottom face part 91 projects outward.

Although three of the case-side cover connecting parts 92 are formed in this embodiment, the number of the case-side cover connecting parts 92 is not limited to such. It should be noted that, like the cover-side case connecting parts 53a, from the viewpoint of stably attaching the light-transmissive cover 90 to the case 50, it is preferable that two or more of the case-side cover connecting parts 92 be formed, and it is more preferable that three or more of the case-side cover connecting parts 92 be formed.

The mirror-side cover connecting parts 93 are connecting parts for connecting with the reflecting mirror 80. Specifically, the mirror-side cover connecting parts 93 have a shape which allows engagement with cover-side mirror connecting parts 82a and 82b of the reflecting mirror 80. More specifically, each of the mirror-side cover connecting parts 93 has a shape in which the tip of the protruding part that protrudes upward from the cover bottom face part 91 projects inward.

Although three of the mirror-side cover connecting parts 93 are formed in this embodiment, the number of the mirror-side cover connecting parts 93 is not limited to such. It should be noted that, like the cover-side mirror connecting parts, in order to prevent the light-transmissive cover 90 from dropping in the case where the connection between the light-transmissive cover 90 and the case 50 breaks, it is preferable that two or more of the mirror-side cover connecting parts 93 be provided, and it is more preferable that three or more of the mirror-side cover connecting parts 93 be provided.

Each of the cover side face parts 94 is disposed between one of the case-side cover connecting parts 92 and one of the mirror-side cover connecting parts 93, and is a side face part of the light-transmissive cover 90 which protrudes upward from the cover bottom face part 91. As shown in the figure, one of two rotation positioning parts 94a for determining the rotation position of the light-transmissive cover 90 is disposed in each of two adjacent cover side face parts 94. The rotation positioning parts 94a are projecting parts which project from the corresponding cover side face parts 94 towards the inside of the light-transmissive cover 90 and are disposed at both sides of one of the mirror-side cover connecting parts 93.

Specifically, the rotation positioning parts 94a determine the rotation position of the light-transmissive cover 90 with respect to the reflecting mirror 80, by interfitting with the cover-side mirror connecting part 82b of the reflecting mirror 80. Here, the one mirror-side cover connecting part 93 and the two rotation positioning parts 94a on both sides of the mirror-side cover connecting part 93 make up the mirror-side cover connecting part 95. The mirror-side cover connecting part 95 engages with the cover-side mirror connecting part 82b.

Here, rotation-regulating part 96 is a tabular part which protrudes upward from the cover bottom face 91, for regulating the rotation of the light-transmissive cover 90. Specifically, the rotation-regulating part 96 regulates the rotation of the light-transmissive cover 90 with respect to the case 50, by abutting the projecting part 53b of the case 50.

Here, as shown in FIG. 7, the three case-side cover connecting parts 92 and the three mirror-side cover connecting parts 93 (or two of the three mirror-side cover connecting parts 93 and the single mirror-side cover connecting part 95) are disposed equidistantly. In other words, the case-side cover connecting parts 92 and the mirror-side cover connecting parts 93 are disposed alternately and equidistantly so that angles R1 to R6 in the figure all have the same angles (60 degrees in the figure).

It should be noted that, in the forgoing description, equidistantly need not necessarily mean precisely equidistant, and is defined as a concept which includes some error. In other words, for example, an error of approximately plus or minus 10 degrees in each of the angles R1 to R6 is acceptable.

Next, the connecting state of the respective connecting parts of the case 50, the reflecting mirror 80, and the light-transmissive cover 90 shall be discussed.

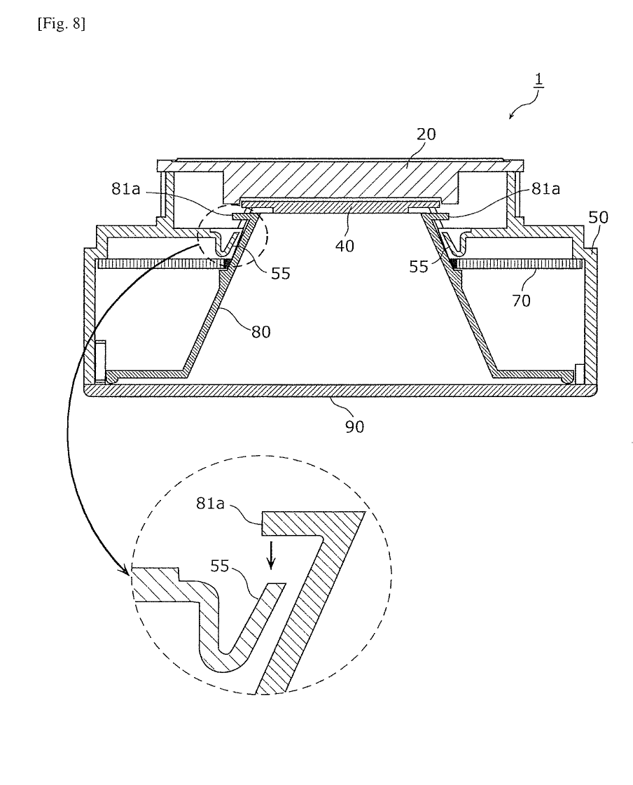

FIG. 8 is diagram showing the connecting state between the case 50 and reflecting mirror 80 according to Embodiment 1 of the present invention. Specifically, the figure is a cross-sectional view of when the lamp 1 shown in FIG. 7 is cut at the cross-section A-A. It should be noted that FIG. 8 is a diagram for illustrating the connecting state between the case 50 and the reflecting mirror 80, and omits the details of the connecting state between the case 50 and the light-transmissive cover 90.

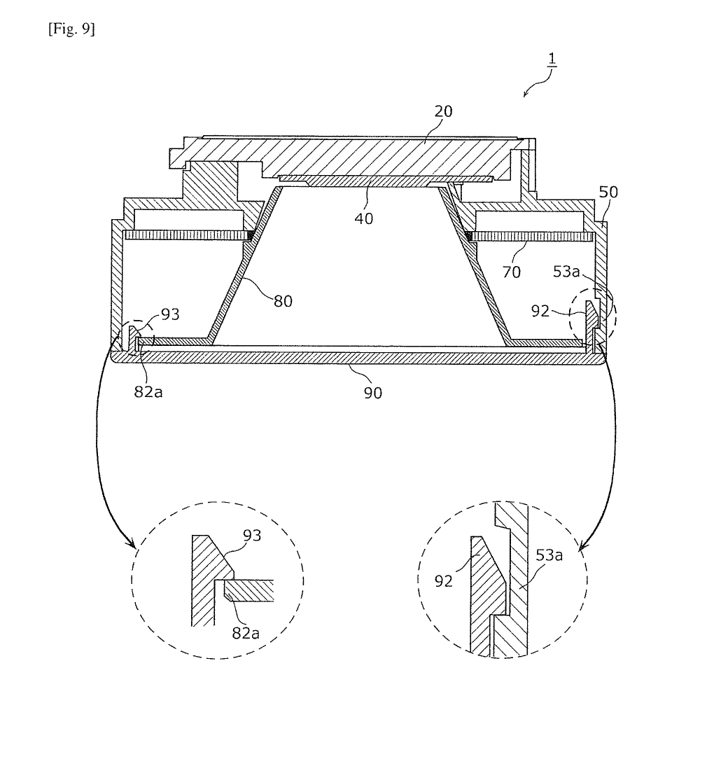

Furthermore, FIG. 9 is diagram showing the connecting state between (i) the light-transmissive cover 90 and (ii) the case 50 and reflecting mirror 80 according to Embodiment 1 of the present invention. Specifically, the figure is a cross-sectional view of when the lamp 1 shown in FIG. 7 is cut at the cross-section B-B.

First, as shown in FIG. 9, the light-transmissive cover 90 and the case 50 are connected through the engagement of the case-side cover connecting parts 92 and the cover-side case connecting parts 53a. Furthermore, the light-transmissive cover 90 and the reflecting mirror 80 are connected through the engagement of the mirror-side cover connecting parts 93 and the cover-side mirror connecting parts 82a.

In contrast, as shown in FIG. 8, the mirror-side case connecting parts 55 of the case 50 and the case-side mirror connecting parts 81a of the reflecting mirror 80 are disposed spaced apart, so as to engage in the case where the reflecting mirror 80 drops. In other words, the mirror-side case connecting parts 55 and the case-side mirror connecting parts 81a engage in the case where the connection between the light-transmissive cover 90 and the case 50 shown in FIG. 9 breaks and the light-transmissive cover 90 drops together with the reflecting mirror 80.

In this case, since the reflecting mirror 80 and the light-transmissive cover 90 are engaged as shown in FIG. 9, the engagement of the mirror-side case connecting parts 55 and the case-side mirror connecting parts 81a can prevent the dropping of not only the reflecting mirror 80 but also the light-transmissive cover 90.

It should be noted that the mirror-side case connecting parts 55 and the case-side mirror connecting parts 81a may also be in an engaged state, that is, without being spaced apart. Furthermore, it is also acceptable that the mirror-side case connecting parts 55 and the case-side mirror connecting parts 81a are in an engaged state, and the case-side cover connecting parts 92 and the cover-side case connecting parts 53a are disposed spaced apart, or that the mirror-side cover connecting parts 93 and the cover-side mirror connecting parts 82a are disposed spaced apart. In any case, when the engagement between one set of the connecting parts fails, the dropping of components can be prevented since the other two sets of connecting parts become engaged.

As described above, according to the lamp 1 according to Embodiment 1 of the present invention, the case 50, the reflecting mirror 80, and the light-transmissive cover 90 are interconnected. Specifically, the lamp 1 is configured in such a way that the case-side mirror connecting parts 81a and the mirror-side case connecting parts 55 are connected, the cover-side case connecting parts 53a and the case-side cover connecting parts 92 are connected, and the mirror-side cover connecting parts 93 and the cover-side mirror connecting parts 82a are connected. As such, even when one connection from among the connections between the case 50, the reflecting mirror 80, and the light-transmissive cover 90 breaks due to deterioration caused by heat when the lamp is on, and so on, the dropping of components can be prevented. In this manner, the lamp 1 is lamp having a twofold drop-preventing function.

Furthermore, the lamp 1 is configured in such a way that the case 50, the reflecting mirror 80, and the light-transmissive cover 90 can connect with one another at the respective connection points. Specifically, the lamp 1 has a form which allows mutual engagement between: the case-side mirror connecting parts 81a and the mirror-side case connecting parts 55; the cover-side case connecting parts 53a and the case-side cover connecting parts 92; and the mirror-side cover connecting parts 93 and the cover-side mirror connecting parts 82a. As such, in the lamp 1, the case 50, the reflecting mirror 80, and the light-transmissive cover 90 can be interconnected simply, without the use of an adhesive.

Furthermore, the connection points of the case 50, the reflecting mirror 80, and the light-transmissive cover 90 of the lamp 1 are arranged equidistantly along a circle. Specifically, the lamp 1 is configured in such a way that the case-side mirror connecting parts 81a and the mirror-side case connecting parts 55, the cover-side case connecting parts 53a and the case-side cover connecting parts 92, and the mirror-side cover connecting parts 93 and the cover-side mirror connecting parts 82a are arranged equidistantly along a circle. As such, even when one connection from among the connections between the case 50, the reflecting mirror 80, and the light-transmissive cover 90 breaks, the dropping of components can be prevented by the other two connections which are arranged equidistantly along a circle.

Furthermore, the case-side cover connecting parts 92 and the mirror-side cover connecting parts 93 are arranged along their respective loops, in different positions when seen from the center of the lamp. With this, the case-side cover connecting parts 92 and the mirror-side cover connecting parts 93 can be fabricated easily during the manufacturing of the light-transmissive cover 90.

Furthermore, since the light-transmissive cover 90 includes the rotation positioning parts 94a, the rotation position of the light-transmissive cover 90 with respect to the reflecting mirror 80 can be determined easily.

Furthermore, since the light-transmissive cover 90 includes the rotation-regulating part 96, the rotation position of the light-transmissive cover 90 with respect to the case 50 can be easily regulated.

### Embodiment 2

Next, a lighting apparatus 100 according to Embodiment 2 of the present invention shall be described.

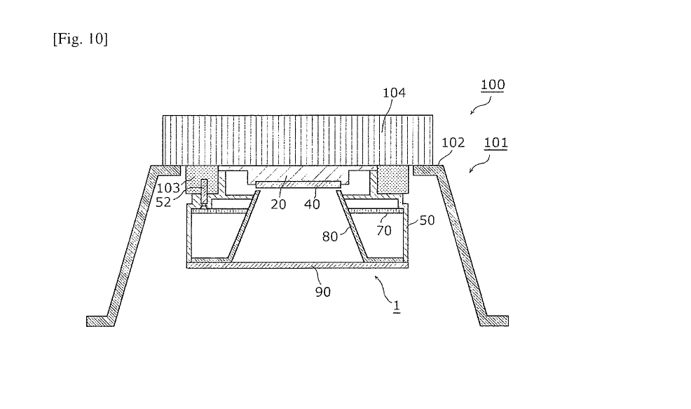

FIG. 10 is a cross-sectional view of a configuration of the lighting apparatus 100 according to Embodiment 2 of the present invention. It should be noted that the lamp 1 according to Embodiment 1 is used in the lighting apparatus according to this embodiment. Therefore, in the figure, the same reference signs are given to structural components that are the same as the structural components shown in Embodiment 1.

As shown in the figure, the lighting apparatus 100 is, for example, a downlight and includes lighting equipment 101, and the lamp 1 according to Embodiment 1. The lighting equipment 101 includes: a main body which includes a reflecting plate 102 and a heat-dissipating component 104 and is configured to cover the lamp 1; and a socket 103 attached to the main body.

The reflecting plate 102 is substantially in the shape of a cup having a circular opening formed on the top face, and is configured so as to laterally surround the lamp 1. Specifically, the reflecting plate 102 includes: as the top face, a circular flat plate part in which a circular opening is formed; and a cylinder part that is formed to have an inner diameter which gradually widens from the periphery of the flat plate part to the bottom. The cylinder part has an opening on the light-emission-side, and is configured to reflect the light from the lamp 1. For example, the reflecting plate 102 is made of a white synthetic resin having insulation properties. It should be noted that, in order to improve reflectivity, the inner face of the reflecting plate 102 may be coated with a reflective film. Moreover, the reflecting plate 102 is not limited to a reflecting plate made of synthetic resin, and a metal reflective plate formed from a pressed metal plate may be used.

The socket 103 is compatible with the GH76p base, and is a disk-shaped component that supplies AC power to the lamp 1. The socket 103 is arranged so that its upper part is inserted inside the opening formed in the flat plate part in the top face of the reflecting plate 102. An opening part shaped to conform to the shape of the base of the support 20 is formed at the center of the socket 103, and the top face of the lamp 1 and the bottom face of the heat-dissipating component 104 are thermally connected by installing the lamp 1 in such opening part. Furthermore, a connection hole into which an electrical connection pin 52 is inserted is formed at a position at the bottom part of the socket 103 which corresponds to the electrical connection pin 52 of the case 50.

The heat-dissipating component 104 is a component which dissipates the heat transmitted from the lamp 1. The heat-dissipating component 104 is disposed to abut the top face of the reflecting plate 102 and the top face of the socket 103. It is preferable that the heat-dissipating component 104 be made of highly heat-conductive material such as aluminum.

It should be noted that the lamp 1 is installed in the socket 103 in a removable manner.

As described above, according to the lighting apparatus 100 according to Embodiment 2 of the present invention, the inclusion of the lamp 1 according to Embodiment 1 makes it possible to produce the same advantageous effects as in Embodiment 1.

Although a lamp and a lighting apparatus according to the embodiments of the present invention have been described, the present invention is not limited to the above-described embodiments.

Specifically, the embodiments disclosed herein should be considered, in all points, as examples and are thus not limiting. The scope of the present invention is defined not by the foregoing description but by the Claims, and includes all modifications that have equivalent meaning to and/or are within the scope of the Claims.

For example, although the case 50, the reflecting mirror 80, and the light-transmissive cover 90 are connected by engaging with one another in the above-described embodiments, the form of connection is not limited to such engagement, and connection by interfitting is also acceptable.

Furthermore, although the case 50, the reflecting mirror 80, and the light-transmissive cover 90 are circular components in the above-described embodiments, their shape is not limited to such. For example, the case 50, the reflecting mirror 80, and the light-transmissive cover 90 may be components of a polygonal shape such as elliptical, quadrangular, or pentagonal. In this case, the respective connecting parts are arranged equidistantly along the elliptical or polygonal loop.

Furthermore, although the entirety of the reflecting mirror 80 is disposed inside the case 50, it is also acceptable to have only part of the reflecting mirror 80 disposed inside the case 50. Likewise, each of the heat-conducting sheet 30, the mounting board 40, and the circuit board 70 may be entirely or partially disposed outside the case 50.

Furthermore, optical components such as a lens or reflector for focusing the light from the light-emitting unit 41, or optical filters, and the like, for color tone-adjustment may be used in the above-described embodiments. However, such components are not essential components for the present invention.

Furthermore, although LEDs are used as an example of light-emitting elements in the above-described embodiments, other light-emitting elements such as semiconductor lasers or organic electro luminescence (EL) devices may also be used.

### INDUSTRIAL APPLICABILITY

The lamp according to the present invention can be widely used as a lamp, or the like, that includes, for example, a GH76p base.

### REFERENCE SIGNS LIST

1 Lamp
10 Heat-conducting sheet
20 Support
30 Heat-conducting sheet
40 Mounting board
41 Light-emitting unit
50 Case
51, 51a-51e Through hole
52, 52a-52e Electrical connection pin
53 Case side face part
53a Cover-side case connecting part
53b Projecting part
54 Case top face part
54a-54c Screw insertion part
55 Mirror-side case connecting part
60 Securing screws
70 Circuit board
80 Reflecting mirror
81 Reflecting mirror side face part
8I a Case-side reflecting mirror connecting part
82 Reflecting mirror bottom face part
82a, 82b Cover-side reflecting mirror connecting part
90 Light-transmissive cover
91 Cover bottom face part
92 Case-side cover connecting part
93, 95 Mirror-side cover connecting part
94 Cover side face part
94a Rotation positioning part
96 Rotation regulating part
100 Lighting apparatus
101 Lighting equipment
102 Reflecting plate
103 Socket
104 Light-dissipating component

1-7. (canceled)

8. A lamp that emits light, the lamp comprising:
a board on which a light-emitting element is provided;
a reflecting component which is disposed on a light-emission-side of the board, and reflects light emitted from the light-emitting element;
a case inside which the reflecting component is entirely or partially disposed, and which has an opening formed on the light-emission side; and
a cover component which covers the opening formed in the case,
wherein the reflecting component includes a case-side reflecting component connecting part for connecting with the case, and the case includes a reflecting component-side case connecting part which connects with the case-side reflecting component connecting part,
the case further includes a cover-side case connecting part for connecting with the cover component, and the cover component includes a case-side cover connecting part which connects with the cover-side case connecting part, and
the cover component further includes a reflecting component-side cover connecting part for connecting with the reflecting component, and the reflecting component further includes a cover-side reflecting component connecting part which connects with the reflecting component-side cover connecting part.

9. The lamp according to claim 8,
wherein the reflecting component-side case connecting part is disposed on a light-emission-side of the case-side reflecting component connecting part, and
the case-side reflecting component connecting part and the reflecting component-side case connecting part are shaped to be engageable with each other.

10. The lamp according to claim 8,
wherein the case-side cover connecting part is shaped to project outside the cover component, and is disposed inside the cover-side case connecting part, and
the cover-side case connecting part and the case-side cover connecting part are shaped to be engageable with each other.

11. The lamp according to claim 8,
wherein the cover-side reflecting component connecting part is disposed on a light-emission-side of the reflecting component-side cover connecting part, and
the reflecting component-side cover connecting part and the cover-side reflecting component connecting part are shaped to be engageable with each other.

12. The lamp according to claim 8,
wherein the reflecting component includes a plurality of the case-side reflecting component connecting parts which are arranged equidistantly along a loop, and the case includes a plurality of the reflecting component-side case connecting parts each of which corresponds to a different one of the case-side reflecting component connecting parts,
the case includes a plurality of the cover-side case connecting parts which are arranged equidistantly along a loop, and the cover component includes a plurality of the case-side cover connecting parts each of which corresponds to a different one of the cover-side case connecting parts, and
the cover component includes a plurality of the reflecting component-side cover connecting parts which are arranged equidistantly along a loop, and the reflecting component includes a plurality of the cover-side reflecting component connecting parts each of which corresponds to a different one of the reflecting component-side cover connecting parts.

13. The lamp according to claim 8,
wherein, when seen from a center of the lamp, one or more case-side cover connecting parts including the case-side cover connecting part are arranged in a loop at positions which are different from positions, in a loop, at which one or more reflecting component-side cover connecting parts including the reflecting component-side cover connecting part are arranged.

14. The lamp according to claim 8,
wherein the cover component further includes a rotation positioning part located at both sides of the reflecting component-side cover connecting part, the rotation positioning part determining a rotation position of the cover component with respect to the reflecting component by interfitting with the cover-side reflecting component connecting part.

15. The lamp according to claim 8,
wherein the cover component further includes a rotation regulating part which regulates rotation of the cover component with respect to the case, by abutting a projecting part of the case which projects towards an inside of the case.

16. A lighting apparatus comprising:
the lamp according to claim 8; and
lighting equipment to which the lamp is attached,
wherein the lighting equipment includes:
a main body configured to cover the lamp; and
a socket attached to the main body, for supplying power to the lamp.
